(19) United States
(12) Patent Application Publication
(10) Pub. No.: US 2026/0176421 A1
(43) Pub. Date: Jun. 25, 2026

(54) NON-ISOCYANATE EXPANDED POLYURETHANE, METHODS FOR PRODUCING IT AND ITS USES

(71) Applicants: COMMISSARIAT A L'ENERGIE ATOMIQUE ET AUX ENERGIES ALTERNATIVES, PARIS (FR); FAURECIA SIEGES D'AUTOMOBILE, NANTERRE (FR)

(72) Inventors: Anthony MONMAGNON, Grenoble Cedex 09 (FR); Sébastien ROLERE, Grenoble Cedex 09 (FR); Renaud DEMADRILLE, Grenoble Cedex 09 (FR); Jaouad EL HARFI, Morigny-Champigny (FR)

(73) Assignees: COMMISSARIAT A L'ENERGIE ATOMIQUE ET AUX ENERGIES ALTERNATIVES, PARIS (FR); FAURECIA SIEGES D'AUTOMOBILE, NANTERRE (FR)

(21) Appl. No.: 19/426,643

(22) Filed: Dec. 19, 2025

(30) Foreign Application Priority Data
Dec. 20, 2024 (FR) FR2414928

(51) Int. Cl. C08G 71/04; C08J 9/08

(52) U.S. Cl. CPC C08G 71/04; C08J 9/08; C08J 2203/02; C08J 2375/04

(57) ABSTRACT

This disclosure concerns a non-isocyanate-type expanded polyurethane, its production methods, in particular by microwave irradiation, and its uses. This disclosure relates in particular to a bio-sourced isocyanate-free polyurethane foam, its production methods, in particular by microwave irradiation, and its uses.

### CROSS-REFERENCE(S) TO RELATED APPLICATION(S)

This application claims priority to FR 2414928, filed Dec. 20, 2024, the disclosure of which is hereby expressly incorporated by reference herein in its entirety.

### TECHNICAL FIELD

This disclosure concerns a non-isocyanate type expanded polyurethane, its production methods, in particular by microwave irradiation, and its uses. This disclosure relates in particular to a bio-sourced isocyanate-free polyurethane foam, its production methods, in particular by microwave irradiation, and its uses.

### BACKGROUND

Polyurethanes (PU) are cross-linked polymer materials used mainly in the form of foams for thermal insulation and furniture (mattresses, car seats). Due to the use of isocyanates (groups with the formula —N═C—O) in their formulation, PU materials have a high impact on the environment and the health of formulators. Against this backdrop, the European Union recently amended the REACH regulation (an acronym for “Registration, Evaluation, Authorization and restriction of CHemicals regulation”; REACH is a European regulation designed to improve the protection of human health and the environment against the potential risks of chemical substances) to apply new restrictions on the use of products containing more than 0.1% diisocyanate monomers. These restrictions apply to adhesives, sealants and polyurethane foams used in industrial production and construction work.

The development of new PU synthesis routes based on less harmful and possibly bio-sourced precursors is therefore of great interest to industry.

Non-isocyanate polyurethanes (NIPU) are promising materials for reducing the environmental impact of PU materials. Polyhydroxyurethane (PHU) NIPU are obtained by reacting polyamines with cyclic carbonates, thereby eliminating the need for isocyanates. This production method offers a number of significant advantages:
The absence of isocyanate in the production of NIPU considerably reduces the health risks for workers and end users. Isocyanates are known to be respiratory and skin irritants, and eliminating them improves working conditions and reduces the risk of allergies and asthma;
NIPU production is more environmentally friendly. Isocyanates are volatile compounds that contribute to air pollution and the formation of smog. By using cyclic carbonates, the emissions of volatile organic compounds (VOC) are reduced, which lowers the carbon footprint of the production process;
NIPU have mechanical and thermal properties comparable to, or even better than, those of traditional polyurethanes. They offer a good abrasion resistance, an increased flexibility and durability, making them suitable for a variety of industrial applications.

As a replacement for conventional PU, NIPU may find applications in various fields thanks to their unique properties and reduced environmental impact, for example as coatings and paints, adhesives and sealants, elastomers, composites, technical textiles, and in particular as foams. NIPU foams may, for example, be used in thermal and acoustic insulation, as well as in upholstery applications.

However, the molecules used in NIPU cross-linking (cyclic carbonates, amines) have lower reactivities than the isocyanates used in the manufacture of conventional PU, resulting in longer cross-linking times that are currently incompatible with the production rates expected for this type of material. Treatment times of 12 hours at a temperature of 100° C. are sometimes necessary. This may limit their widespread adoption, especially in cost-sensitive industries.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aim of the present disclosure is therefore to make available an expanded NIPU obtained using a method that accelerates the cross-linking kinetics of the NIPU foams, with a view to making them economically viable as a replacement for current PU foams.

Another aim of the present disclosure is to provide such compounds from bio-sourced reagents, forming a highly reactive composition.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 describes the spectra obtained by Fourier transform infrared spectroscopy (FTIR) of carbonated hemp oil and expanded NIPU according to an embodiment of the present disclosure.

FIG. 2A corresponds to images obtained by scanning electron microscopy (SEM) of cells in a foam according to an embodiment of the present disclosure.

FIG. 2B corresponds to images obtained by scanning electron microscopy (SEM) of cells in a foam according to an embodiment of the present disclosure.

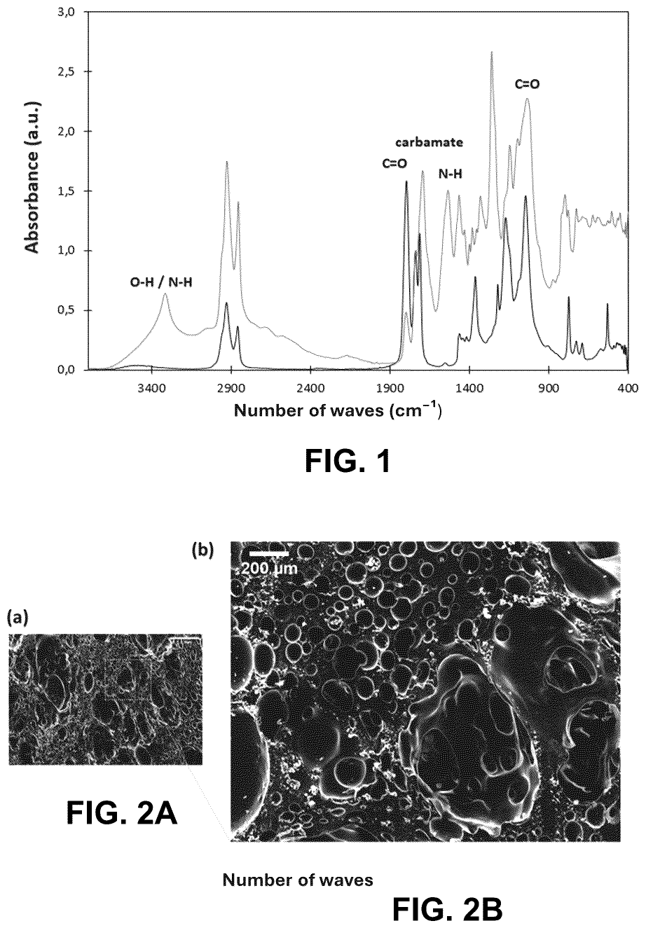

### DETAILED DESCRIPTION

“Bio-sourced” means derived from renewable organic matter of microbial, plant, fungal or animal origin, particularly vegetable.

The present disclosure therefore relates to a non-isocyanate cross-linked expanded polyurethane formed by cross-linking at least one compound A, in particular a compound A, and at least one compound B, in particular a compound B,
the at least one compound A being a compound comprising at least two cyclic carbonate functions,
the at least one compound B being a compound carrying at least two primary amine groups, the polyurethane having:
a glass transition temperature Tg of between −26 and −5° C., for example approximately −26° C., as measured in particular by differential scanning calorimetry;
an extractable matter content of 5.2 to 8.1%, for example approximately 5.6%, as measured in particular after immersion of a cross-linked sample for 24 hours in tetrahydrofuran at room temperature;
a density of 120-240 kg/m³, for example approximately 190 kg/m³;
an average cell size of between 120 and 240 μm, for example approximately 150 μm, as measured in particular by scanning electron microscopy;
a compression modulus ranging from 83 to 511 kPa, for example approximately 511 kPa, as measured in particular by successive compression/decompression tests;
a residual deformation after 5 compression/decompression cycles ranging from 0.7 to 6%, for example approximately 0.7%;
a gel time at 80° C. of approximately 5.2 minutes, as measured in particular by rheometry at the point of intersection of the elastic and viscous moduli in shear; and/or
a thermal stability up to 225° C., as assessed in particular by gravimetric thermal analysis.

According to a particular embodiment, the non-isocyanate cross-linked expanded polyurethane is formed by cross-linking a compound A and at least one compound B.

In a particular embodiment, the non-isocyanate cross-linked expanded polyurethane is formed by cross-linking a compound A and a compound B.

According to a particular embodiment, the polyurethane has a glass transition temperature Tg of between −26 and −5° C.

Surprisingly, the NIPU of the invention were obtained during a method wherein two independent phenomena-cross-linking and foaming-occur simultaneously, in particular during microwave irradiation. However, this compromise is difficult to find, as cross-linking before foaming does not produce the desired foam, and foaming before cross-linking leads to a compound whose mechanical properties may not maintain the honeycomb structure formed, which collapses.

The cyclic carbonate functions comprise at least 5 atoms, including 3 —O—C—O— atoms of the —O—C(═O)—O— pattern, and at least two carbon atoms carrying the pattern.

According to a particular embodiment, the at least two cyclic carbonate functions have a ring which comprises (or consists of) 5 to 8 atoms.

A cyclic carbonate function with a ring comprising (or consisting of) 5 to 8 atoms corresponds to a cyclic carbonate function comprising (or consisting of) 6 to 9 atoms (counting the carbonyl oxygen (O—(C═O)—O)).

According to a particular embodiment, the at least one compound A is a compound comprising from 2 to 8 cyclic carbonate functions, in particular from 2 to 3, 4, 5, 6 or 7 cyclic carbonate functions.

According to a particular embodiment, the at least one compound A is a carbonated vegetable oil, a carbonated polyglycerol or carbonated 2-ethyl-2-(hydroxymethyl)propane-1,3-diol.

According to a particular embodiment, the at least one compound A is a carbonated vegetable oil.

In a particular embodiment, the at least one compound A is a fully carbonated vegetable oil.

According to a particular embodiment, the at least one compound A is a fully carbonated vegetable oil comprising from 2 to 7 cyclic carbonate functions.

According to a particular embodiment, the at least one compound A is a partially carbonated vegetable oil.

By “partially carbonated”, we mean in particular that the vegetable oil carries, in addition to the at least two cyclic carbonate functions, at least one epoxide function.

According to a particular embodiment, the at least one compound A is a partially carbonated vegetable oil comprising from 2 to 5 or 6 cyclic carbonate functions.

The carbonated vegetable oils may be obtained by any technique well known to the person skilled in the art, in particular by epoxidation followed by carbonation.

The epoxidation reaction refers to the functionalization of unsaturations (double bonds) into epoxide groups using pure oxygen or hydrogen peroxide. The chemo-enzymatic epoxidation and Prileschajew epoxidation are the two main epoxidation methods used.

The carbonation step may be carried out using carbon dioxide and a catalyst, for example at around 100° C. A large number of catalyst systems have been reported in the literature for this reaction, of which alkali metal halides, quaternary ammonium halides and polystyrene-bound quaternary ammonium salts are generally the most effective.

According to a particular embodiment, the at least one compound A is a carbonated polyglycerol.

According to a particular embodiment, the at least one compound A is a polyglycerol wherein at least two of the —OH groups carry a residue comprising a cyclic carbonate function.

According to a more particular embodiment, the at least one compound A is a polyglycerol wherein at least two of the —OH groups form ethers of the following formula (I)

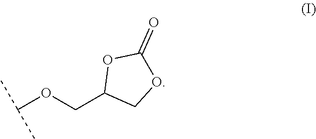

According to a particular embodiment, the at least one compound A is a 2-ethyl-2-(hydroxymethyl)propane-1,3-diol wherein at least two of the —OH groups carry a residue comprising a cyclic carbonate function.

According to a more particular embodiment, the at least one compound A is a 2-ethyl-2-(hydroxymethyl)propane-1,3-diol wherein at least two of the —OH groups form ethers of the following formula (I):

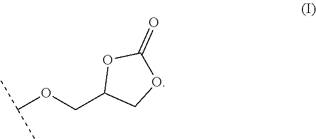

According to a particular embodiment, the at least one compound A is 2-ethyl-2-(hydroxymethyl)propane-1,3-diol comprising 2 or 3 cyclic carbonate functions.

The carbonated polyglycerols and carbonated 2-ethyl-2-(hydroxymethyl)propane-1,3-diols may be obtained by any technique well known to the person skilled in the art, in particular by carbonation (as for example mentioned above) of the corresponding epoxy compounds, which are for example commercial.

According to a particular embodiment, the at least one compound A is selected from the following compounds:

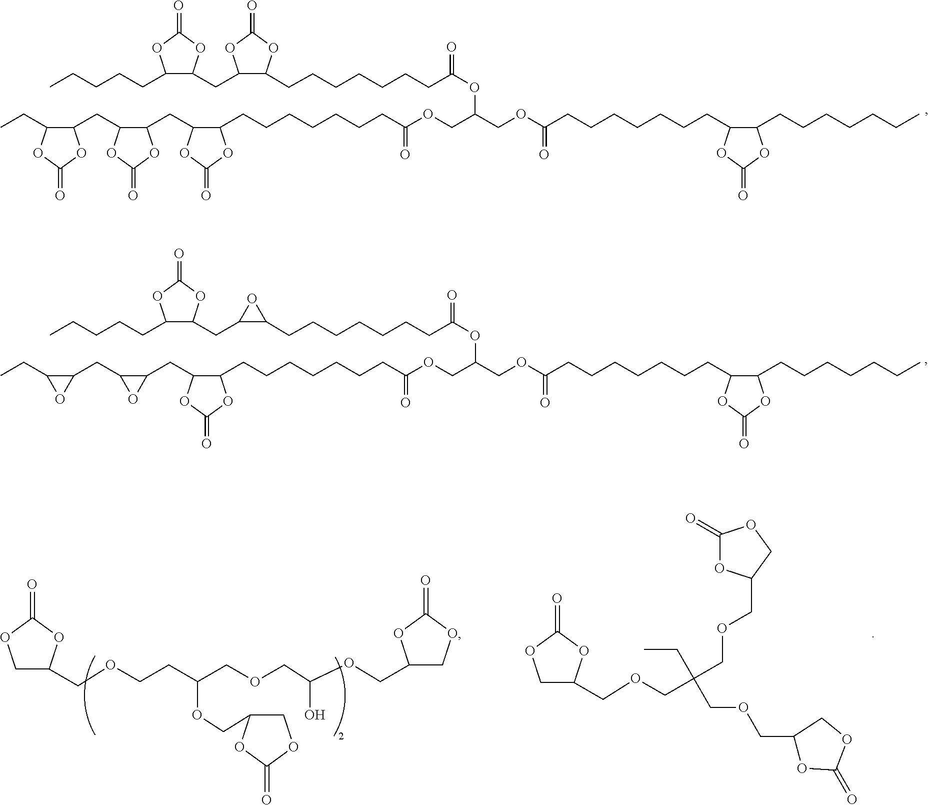

According to a particular embodiment, the at least one compound B is a compound carrying two or three primary amine groups.

According to a particular embodiment, the at least one compound B is a compound of the following formula (II):

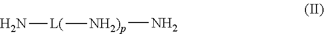

wherein:
p is equal to 0 or 1;
L is a linear, branched and/or cyclic (C₃ to C₂₀) or even (C₃ to C₄₀) alkane diyl (when p=0) or triyl (when p=1), optionally:

interrupted by at least one element chosen from an O atom, an N atom and an NH group; and/or
substituted by at least one-OH group; and/or
unsaturated, in particular mono- or di-unsaturated.

Examples of such compounds include:
alkylene diamines and alkylene triamines, each comprising two or three primary amino groups —NH₂,
cycloalkylene diamines and triamines, each comprising two or three primary amino groups —NH₂,
diamines and triamines comprising both alkyl and cycloalkyl groups, comprising two or three primary amino groups —NH₂ respectively,
polyether diamines and polyether triamines, each comprising two or three primary amino groups —NH₂,
polyethylene imines comprising two or three primary amino groups —NH₂,
polypropylene imines comprising two or three primary amino groups —NH₂,
polyamidoamines comprising two or three primary amino groups —NH₂,
unsaturated, in particular mono- or di-unsaturated, linear, branched and/or cyclic (C₃ to C₄₀) alkanes comprising two or three primary amino groups —NH₂, for example of the following formula:

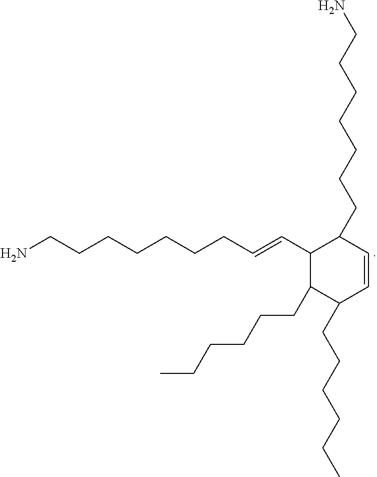 [SMILES: CCCCCCC1C=CC(CCCCCCCN)C(/C=C/CCCCCCCN)C1CCCCCC]

According to a particular embodiment, the at least one compound B is selected from the following compounds:

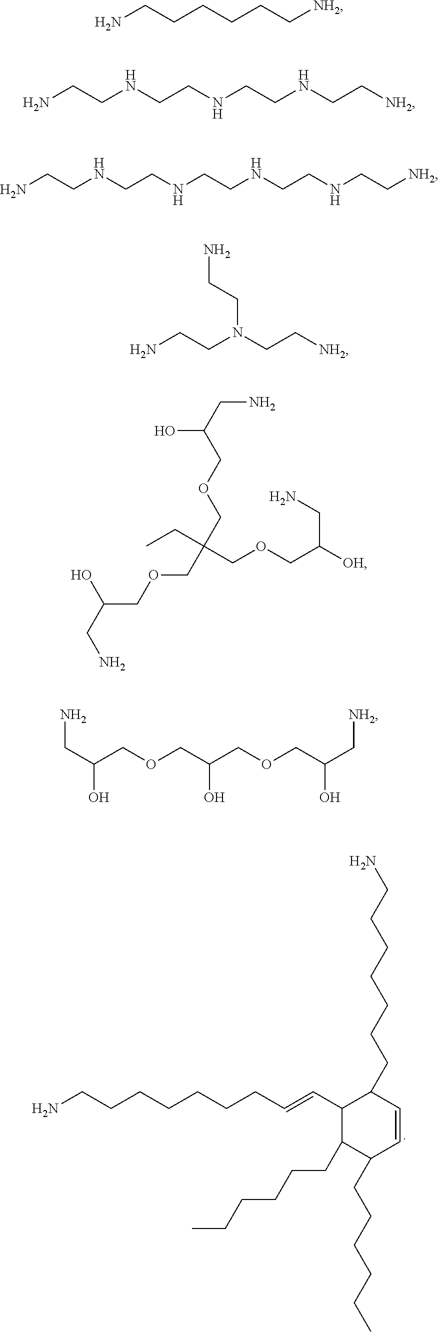

In a particular embodiment, the polyurethane as defined above additionally comprises at least one catalyst.

The cross-linking catalyst or catalysts may be any catalyst typically used to accelerate the cross-linking kinetics between the cyclic carbonate and the amine, in particular the ring-opening reaction of a compound comprising a cyclocarbonate group by a primary amine.

Examples of cross-linking catalysts that may be used according to the invention include:
alcoholates, such as potassium ter-butylate or sodium methanolate;
bases, in particular strong bases, chosen from:
phosphazenes such as 2-tert-butylimino-2-diethylamino-1,3-dimethylperhydro-1,3,2-diazaphosphoride (BMEP),
guanidines such as:
1,5,7-triazabicyclo 4.4.0]dec-5-ene (TBD)

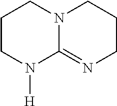

N-methyl 1,5,7-triazabicyclo 4.4.0]dec-5-ene (Me-TBD)

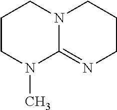

tertiary amines such as:
Tris(2-aminoethyl)amine,
1,8-diazabicyclo[5.4.0]undec-7-ene (DBU)

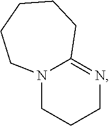 [SMILES: C1CCC2=NCCCN2CC1]

1,5-diazabicyclo[4.3.0]non-5-ene (DBN),

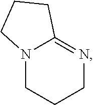

2,2′-morpholine diethyl ether (DMDEE)

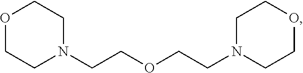 [SMILES: C1CN(CCOCCN2CCOCC2)CCO1]

1,4-diazabicyclo[2.2.2]octane (DABCO)

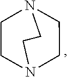

thioureas, for example 1-(3,5-bis(trifluoromethyl)phenyl)-3-butylthiourea.

An amount ranging from 0.05 to 5% by weight of cross-linking catalysts relative to the total weight of the multi-component system according to the invention may be used.

Adding a catalyst accelerates the cross-linking and the foam expansion.

According to another aspect, the present disclosure also relates to the use of at least one compound A and at least one compound B as defined above, for the preparation of a non-isocyanate cross-linked expanded polyurethane.

All the embodiments previously defined in relation to polyurethane also apply here, alone or in combination.

According to another aspect, the present disclosure also relates to the use of a non-isocyanate cross-linked expanded polyurethane for the design of mattresses or seat cushions, or foam sheets, particularly for thermal insulation.

All the embodiments previously defined in relation to polyurethane also apply here, alone or in combination.

According to another aspect, the present disclosure also relates to the use of at least one microwave irradiation of a composition comprising at least one compound A and at least one compound B as defined above for the preparation of a non-isocyanate cross-linked expanded polyurethane.

All the embodiments previously defined in relation to polyurethane also apply here, alone or in combination.

According to another aspect, the present disclosure also relates to a method for producing a non-isocyanate cross-linked expanded polyurethane comprising a step (i) of heating a reaction mixture comprising:
at least one compound A as defined above,
at least one compound B as defined above,
at least one catalyst as defined above, and
at least one expansion agent.

All the embodiments previously defined in relation to polyurethane also apply here, alone or in combination.

According to one embodiment, the reaction mixture comprises, by mass relative to the total mass of the reaction mixture:
from 40 to 90%, for example from 59 to 75%, of at least one compound A as defined above,
from 10 to 50%, for example from 20 to 55%, of at least one compound B as defined above,
from 0.05 to 5%, for example about 1.3%, of at least one catalyst as defined above, and
1 to 10%, for example 2 to 7%, of at least one expansion agent.

The expansion agent according to the present present disclosure may be of any known type.

In a particular embodiment, the expansion agent is a chemical expansion agent.

There are physical or chemical expansion agents, of the endothermic or exothermic type.

It may also be a “chemical” expansion agent, i.e. a substance (or mixture of substances) dissolved or dispersed in the plastic which, under the effect of temperature, releases the gas or gases which will be used to expand the plastic.

Chemical expansion agents are preferably used, more preferably chemical expansion agents of the exothermic type such as, in particular, water, diazo compounds, dinitroso compounds, hydrazides, carbazides, semi-carbazides, tetrazoles, carbonates and citrates, as described in particular in the aforementioned applications WO 2011/064128, WO 2012/163998 and WO 2013/092340.

In a particular embodiment, the chemical expansion agent is carbonate-based, for example ammonium bicarbonate.

Examples of such substances are water, azodicarbonamide and/or mixtures of bicarbonate, for example ammonium or sodium bicarbonate, and citric acid.

According to a particular embodiment, the expansion agent comprises or consists of water and/or a mixture of bicarbonate, in particular ammonium bicarbonate and a compound configured to generate CO₂, at moderate temperature (i.e. in particular at a temperature <150° C.).

The compound may be chosen from citric acid, cis-aconite acid, trans-aconite acid, their salts and mixtures thereof.

The compound is in particular citric acid or one of its salts, or an amine —CO₂ adduct, more particularly citric acid or one of its salts.

In a particular embodiment, the expansion agent comprises or consists of water and/or a mixture of ammonium bicarbonate and citric acid or one of its salts.

In a particular embodiment, the expansion agent consists of water.

In a particular embodiment, the expansion agent consists of a mixture of ammonium bicarbonate and citric acid, for example in stoichiometric proportions (i.e. in a 3:1 molar ratio).

In a particular embodiment, the expansion agent consists of a mixture of water, ammonium bicarbonate and citric acid.

In a particular embodiment, heating in step (i) is performed by microwave irradiation or conventional heating.

The duration and temperature of this conventional heating may be easily determined by a person skilled in the art, in particular as a function of the amine and the epoxide content.

By way of example, step (i) may be carried out for 5 to 15 minutes, and/or at around 80° C.

According to a particular embodiment, the present disclosure relates to the preparation of a non-isocyanate cross-linked expanded polyurethane comprising a step (i) of microwave irradiation of a reaction mixture comprising:
a compound A as defined above,
a compound B as defined above,
a catalyst as defined above, and
an expansion agent.

According to a particular embodiment, the microwave irradiation in step (i) is performed for a period of 1 second to 30 minutes, in particular from 1 to 10 minutes, in particular from 1 or 2 to 3, 4 or 5 minutes.

In a particular embodiment, the microwave irradiation in step (i) is performed at a power of between 50 and 200 W, or even 50 to 250 W.

In a particular embodiment, microwave irradiation in step (i) is carried out in a continuous flow.

In a particular embodiment, the microwave irradiation in step (i) is a single-mode or multi-mode irradiation.

According to a particular embodiment, the temperature reached during the microwave irradiation of step (i), particularly in the enclosure where the irradiation is carried out, is between 2° and 100° C.

According to another aspect, the present disclosure also relates to a non-isocyanate cross-linked expanded polyurethane obtainable by a method as defined above.

All the previously defined embodiments of the polyurethane or the method also apply here, alone or in combination.

### Definitions

As understood here, the value ranges in the form of “x-y” or “from x to y” or “between x and y” include the bounds x and y, the integers between these bounds, and all other real numbers between these bounds. For example, “1-5”, or “from 1 to 5” or “between 1 and 5” refer to the integers 1, 2, 3, 4 and 5, as well as all other real numbers between 1 and 5. Preferred embodiments comprise each individual integer in the value range, as well as any sub-combination of these integers and any set of real numbers between these integers. For example, the preferred values for “1-5” may comprise the integers 1, 2, 3, 4, 5, 1-2, 1-3, 1-4, 1-5, 2-3, 2-4, 2-5, etc.

As used in this description, the term “about” refers to a range of values within ±10% of a specific value. For example, the term “about 20” comprises the values of 20±10%, i.e., the values of 18 to 22.

### EXAMPLES

### Example 1: Preparation of PU According to the Present Disclosure

The formulation developed consists (per 100 g of formulation) of carbonated hemp oil (HCC, 72.1 g), hexamethylenediamine (HMDA, 21.5 g) and 1,5,7-triazabicyclo[4,4,0]dec-5-ene (TBD, 1.27 g) as precursors. During the formulation, the expansion agents which are ammonium bicarbonate (2.78 g), citric acid (2.25 g) and water (0.1 g) are added to the mixture.

Once a homogenous formulation has been obtained, the mixture is poured into a Teflon mold and then placed in the microwave.

The tests were carried out at 80° C. at different microwave powers ranging from 50 W to 200 W for 10 min. The temperature of the formulations is measured using an optical fiber. Under optimum conditions, the foaming and the cross-linking of the NIPU system intervene in less than 5 minutes, making it competitive with conventional PU technologies.

After cross-linking the foam under microwave conditions, characterization by FTIR ATR clearly shows a reduction in the carbonyl (C—O) vibration band of the cyclic carbonates at 1797 cm-1. The FTIR spectrum also shows the vibration band of OH and NH bonds at 3100 cm-1 and the urethane band at 1689 cm-1. Another band characteristic of the N—H bond is present at 1537 cm-1.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A non-isocyanate cross-linked expanded polyurethane formed by cross-linking at least one compound A and at least one compound B,
the at least one compound A being a compound comprising at least two cyclic carbonate functions,
the at least one compound B being a compound carrying at least two primary amine groups,
the polyurethane having a glass transition temperature Tg of between −26 and −5° C.

2. The polyurethane according to claim 1, wherein a ring of the at least two cyclic carbonate functions comprises 5 to 8 atoms.

3. The polyurethane according to claim 1, wherein the at least one compound A is a compound comprising from 2 to 8 cyclic carbonate functions.

4. The polyurethane of claim 1, wherein the at least one compound A is a carbonated vegetable oil, a carbonated polyglycerol or a carbonated 2-ethyl-2-(hydroxymethyl)propane-1,3-diol.

5. The polyurethane of claim 1, wherein the at least one compound A is selected from the following compounds:

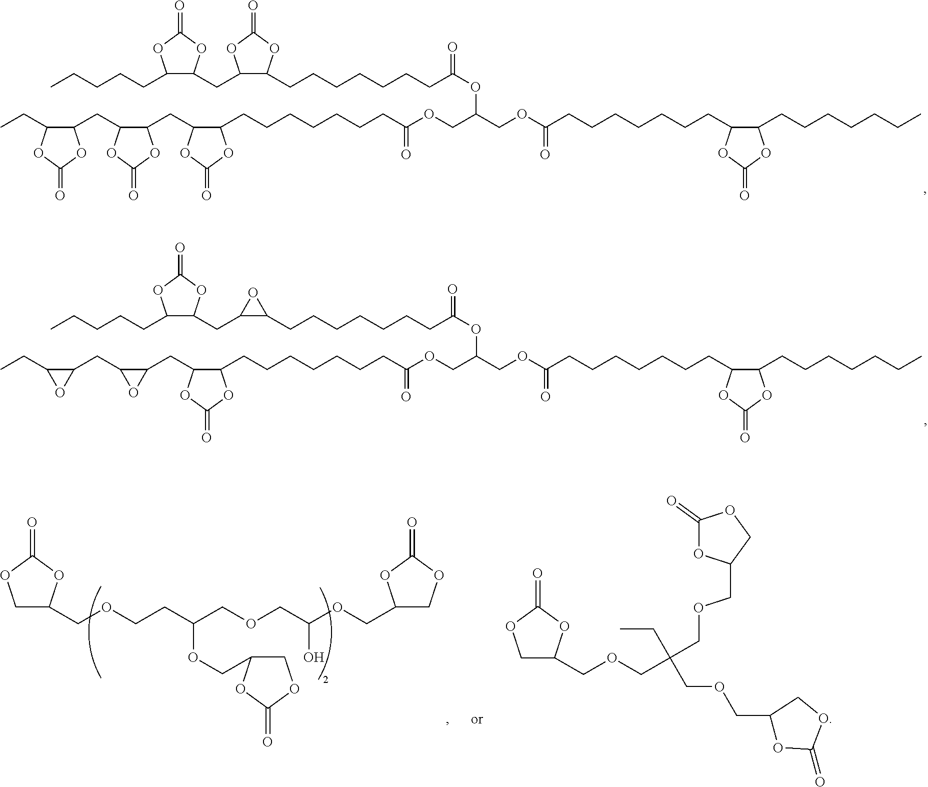

6. The polyurethane of claim 1, wherein the at least one compound B is a compound carrying two or three primary amine groups.

7. The polyurethane of claim 1, wherein the at least one compound B is a compound of the following formula (II): 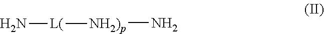
wherein:
p is equal to 0 or 1; and
L is a linear, branched, or cyclic (C₃ to C₄₀) alkane diyl (when p=0) or triyl (when p=1).

8. The polyurethane of claim 1, wherein the at least one compound B is selected from the following compounds:

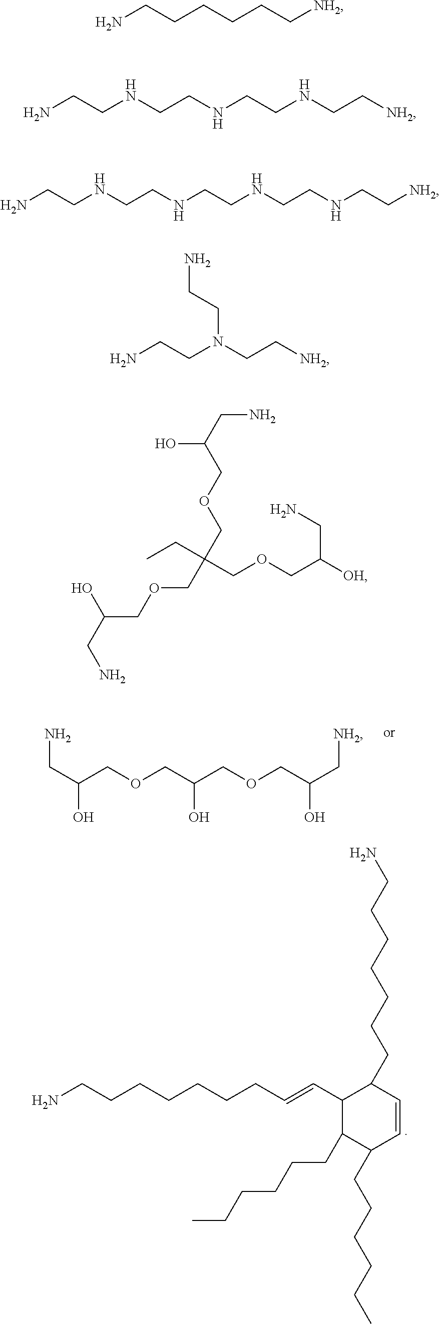

9. A method for producing a non-isocyanate cross-linked expanded polyurethane according to claim 1, comprising a step (i) of heating a reaction mixture comprising:
at least one compound A as defined in claim 1,
at least one compound B as defined in claim 1,
at least one catalyst, and
at least one expansion agent.

10. A method according to claim 9, wherein the expansion agent comprises water and/or a mixture of ammonium bicarbonate and citric acid, or a salt thereof.

11. The method according to claim 9, wherein the heating in step (i) is performed by microwave irradiation.

12. The method according to claim 11, wherein the microwave irradiation in step (i) is performed for a period of 1 s to 30 minutes, and/or at a power of between 50 and 250 W.

13. The polyurethane of claim 7, wherein L is interrupted by at least one element chosen from an O atom, an N atom and an NH group; and/or
L is substituted by at least one-OH group; and/or
L is unsaturated, in particular mono- or di-unsaturated.

14. The method according to claim 12, wherein the microwave irradiation in step (i) is performed for a period of from 1 to 10 minutes.

15. The method according to claim 12, wherein the microwave irradiation in step (i) is performed for a period of from 1 to 5 minutes.

16. The method according to claim 12, wherein the microwave irradiation in step (i) is performed for a period of from 1 to 3 minutes.

17. The method according to claim 12, wherein the microwave irradiation in step (i) is performed for a period of from 2 to 3 minutes.

18. The method according to claim 12, wherein the microwave irradiation in step (i) is performed at a power of between 50 and 200 W.
